(19) United States
(12) Patent Application Publication
(10) Pub. No.: US 2010/0081323 A1
(43) Pub. Date: Apr. 1, 2010

(54) HF HOUSING COUPLER AND METHOD FOR PRODUCING THE SAME

(76) Inventor: Thomas Prockl, Bad Aibling (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/594,741

(22) PCT Filed: Mar. 19, 2008
(86) PCT No.: PCT/EP08/02213

§ 371 Date: Nov. 19, 2009

(30) Foreign Application Priority Data
Apr. 5, 2007 (DE) 10 2007 016 430.2

(51) Int. Cl. H01R 9/05; B29C 45/14

(52) U.S. Cl. 439/578; 264/272.11

(57) ABSTRACT

An HF housing coupler having a connector part connected to a housing is described, which has a connecting structure, via which a coaxial plug can be detachably connected to the connector part in a fixed manner.

The invention is distinguished in that the connector part is implemented as a component differentiable from the housing, and provides at least one region which at least sectionally forms a formfitting connection with a housing wall which can be associated with the housing.

### TECHNICAL AREA

The invention relates to an HF housing coupler having a connector piece which is connected to a housing and comprises a connecting structure, via which a coaxial plug can be detachably connected to the connector piece in a fixed manner. Furthermore, a method for producing an HF housing coupler of this type is described.

### PRIOR ART

HF housing couplers represent plug connectors for coaxial plugs for feeding high-frequency signals into high-frequency components and/or high-frequency assemblies enclosed by housings. HF housing couplers according to the species typically have a connector flange implemented as planar, which presses flush against the outer side of a housing wall and can be detachably attached on the housing in a fixed manner using screw connections.

A housing coupler implemented in this way is described in DE 30 22 102. The metallic connector flange, which has four screw connections for the detachable fixed attachment on a housing wall, is integrally connected to a sleeve-type external conductor, on whose cylindrical external contour a screw thread is incorporated, with which a union nut of a plug can be engaged, for example. The housing coupler additionally has an internal conductor bushing, which is fixed centrally relative to the external conductor via an installation support, inside its sleeve inner chamber, which is spanned like a hollow cylinder.

A similarly implemented HF housing coupler can be inferred from DE 101 27 862 A1, whose square flange is not necessarily integrally connected to the external conductor. The known housing coupler concept also provides the attachment of the coupler to the outer wall of a housing in the course of conventional screw connections.

A housing manufactured from plastic is often used, so that a direct screw connection for fixing the coupler on the plastic housing wall is not possible or is only possible in a limited way for reasons of manufacturing technology, because the plastic is subject to flowing behavior and thus conventional screw connections cannot ensure permanent connection security. For this purpose, so-called threaded nuts, which are typically manufactured from metal, are introduced into the plastic housing at points which are to be aligned with the fastening holes of the connection flange of the HF housing coupler to receive the fastening screws. The introduction of the threaded nuts is preferably performed jointly with the housing production in the context of a plastic injection-molding method. Alternatively, the threaded nuts may also be introduced into the housing after the manufacturing of the housing by subsequent placement of boreholes in the housing wall and corresponding gluing of the threaded nuts in the boreholes.

An HF housing coupler comprising thermoplastic material is known from EP 1 544 963 A1, which is implemented together with the production of the housing in the course of an injection-molding method. For this purpose, the housing coupler represents a module comprising plastic, which is integrally connected to the plastic housing. The housing is subsequently metallized jointly with the housing coupler, in which the internal conductor and an insulating support which supports the internal conductor are finally introduced after the metallization.

### DESCRIPTION OF THE INVENTION

The invention is based on the object of refining an HF housing coupler according to the species having a connector part, which is connected to a housing, and which has a connecting structure, via which a coaxial plug can be detachably connected in a fixed manner to the connector part in such a manner that with simplified production and assembly for an HF housing coupler, improved robustness and increased reliability are to be achieved in regard to a high-quality and continuous signal transmission. The measures required for this purpose are to be as cost-effective as possible and are to be able to be implemented using simple methods. Furthermore, a corresponding method for producing an HF housing coupler of this type is to be disclosed.

The achievement of the object on which the invention is based is disclosed in Claim 1. A method according to the achievement of the object for producing an HF housing coupler is the subject matter of Claim 19. Features which advantageously refine the idea of the invention are the subject matter of the subclaims and can be inferred from the further description, in particular with reference to the exemplary embodiments.

According to the achievement of the object, the HF housing coupler having a connector part, which is connected to a housing, and which has a connecting structure, via which a coaxial plug can be detachably connected to the connector part in a fixed manner, is characterized in that the connector part is implemented as a component differentiable from the housing and provides at least one region, which in at least some sections forms a formfitting connection with a housing wall which can be associated with the housing.

The material from which the connector part is manufactured preferably comprises a wear-free or an extensively wear-free material, preferably from a metal or a material containing metal, so that it is ensured that the connector part, a least in the region of the connecting structure, which is preferably implemented like a thread or a bayonet joint or a combination of both, is not subject to material wear or any other contour degradations on the connecting structure by force-impinged joining, for example, by screwing the thread provided on the coupler side to a union nut of a coaxial plug to be contacted. On the other hand, a close, non-separable connection is produced by the production of a formfitting connection between the housing wall material and the connector part, which is implemented in the course of a molding or casting method, preferably in the course of an injection-molding method, in which the housing itself is primarily also produced.

In order to ensure that the connector part is and also remains connected as rigidly as possible to the housing, i.e., cannot be detached or loosened from the housing composite by external action in the form of torque or traction or pressure forces, the preferably sleeve-like connector part has structures in the form of grooved depressions or web-like protrusions on its sleeve surface in a sleeve section embedded in the housing material, which are capable of absorbing forces acting rotationally and also axially on the sleeve-like connector element and/or dissipating them into the surrounding housing material. In other words, the structures provided in this sleeve section represent an optimization of the formfitting connection between the sleeve-like connector part and the housing, whereby the connector part is fixedly anchored properly inside the housing wall.

The housing wall advantageously encloses the circumferential edge of the sleeve-like connector part completely using a collar, which is preferably set off from the adjoining housing wall by a trough-shaped recess on the peripheral circumference of the collar and/or is implemented in the form of a step-like or web-like protrusion relative to the typically planar housing wall. Detailed remarks in this regard can be inferred from the following description with reference to the exemplary embodiment shown in the drawing.

The reason for the collar-like enclosure of the peripheral edge of the sleeve-like connector part in the area of the housing wall can be seen in the production of a seal which is as fluid-tight as possible between the housing material and the metal connector part, and which results through the shrinking of the plastic material during the cooling procedure upon the production of the housing, whereby a penetration of moisture between housing wall and connector part is prevented. More detailed descriptions in this regard can be inferred from the further description with reference to the exemplary embodiment shown in the figures.

Following the molding and/or injection molding process, in which the injection-molded housing having the connector part partially embedded therein is obtained, a metallization of the housing with the connector part is performed. The metallization is not necessarily to be performed on the entire surface of the housing, however, rather, a hollow channel which penetrates the housing wall is particularly to be metallized on its inner wall, around which the sleeve-like connector part is coaxially situated and along which an HF signal fed in or out via the HF housing coupler is conducted for further processing.

To complete the HF housing coupler, finally an external conductor sleeve, whose external contour is adapted suitably to the internal contour of the sleeve-like connector part, is pressed into the connector part. For this purpose, the external conductor sleeve is already equipped with an inner internal conductor component, which is supported centrally via an installation support in the interior of the external conductor sleeve, preferably via a press fit.

The external conductor sleeve is contacted with the metal layer deposited on the inner wall in the hollow channel by the pressing-in procedure and additionally has an internal cross-section dimensioned identically to the hollow channel at least in the region of the transition to the hollow channel running in the housing wall, in order to ensure a loss-free HF signal conduction between the external conductor sleeve and the metallized hollow channel running along the housing wall.

As previously noted, the installation of the external conductor sleeve in the axial direction lengthwise to the internal contour of the connector part is solely performed in the course of a pressing-in procedure, which is ended as soon as the external conductor sleeve stops on an abutting edge inside the housing wall, through which the maximum join depth of the external conductor sleeve along the connector part is defined. Fundamentally, no further joining measures, such as the provision and introduction of adhesively acting joining agents or other fixing measures are necessary for the external conductor sleeve.

To ensure a secure seat of the external conductor sleeve even during a plug connection axially fixed inside the connector part, in addition to the press fit between external conductor sleeve and connector part, which is active in any case, a contact pressure force acting axially on the external conductor sleeve, which is produced by a plug unit seated on the HF housing coupler, also acts. The equal contact pressure force acting between the HF housing coupler and the plug unit also ensures that in the connected state between a plug unit seated on the coupler, the particular coupler-side and plug-side external conductor sleeves are under mechanical bias tension, which is oriented in each case in the axial direction in the direction of the housing wall. For this purpose, frontal or support faces provided on the coupler side and plug side on each of the external conductor sleeves are brought into mutual close contact with application of force, whereby the electrical contact between the external conductor sleeves of plug and housing coupler is finally produced. Further details in this regard may be inferred from the further description with reference to the exemplary embodiment shown in the drawing.

### BRIEF DESCRIPTION OF THE INVENTION

The invention is described for exemplary purposes hereafter without restriction of the general idea of the invention on the basis of exemplary embodiments with reference to the drawings. In the figures:

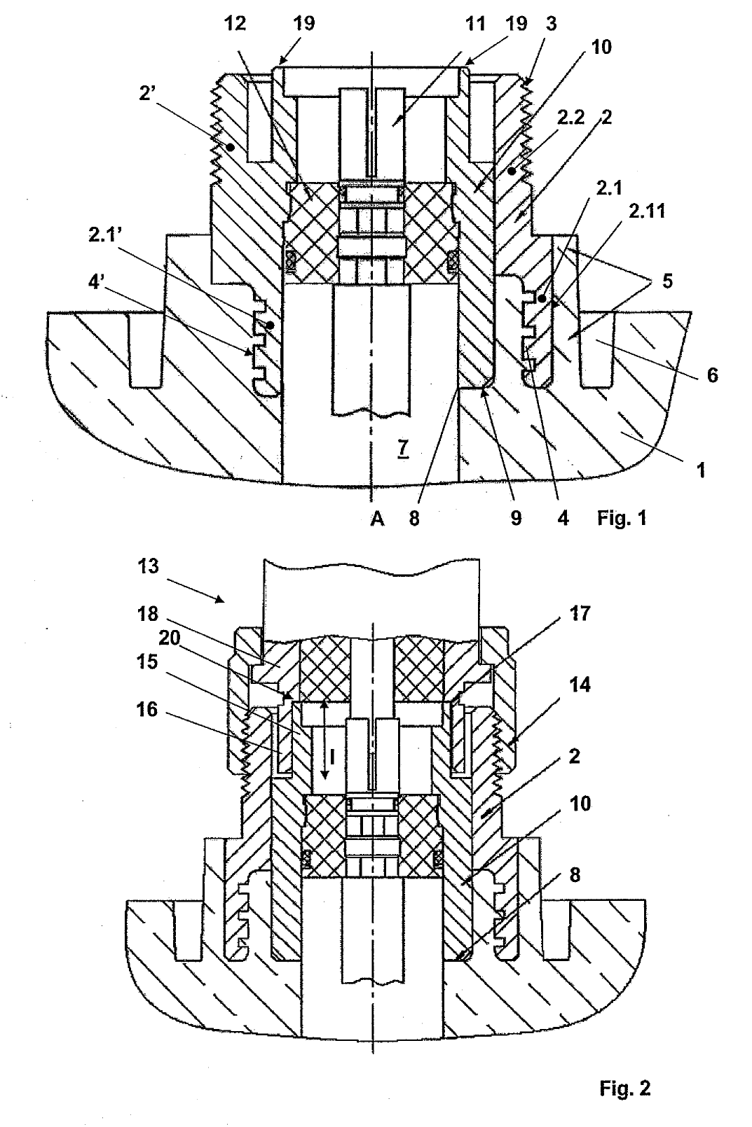

FIG. 1 shows a longitudinal sectional illustration through an HF housing coupler, implemented according to the achievement of the object, which shows two alternative embodiments,

FIG. 2 shows a longitudinal sectional illustration through an HF housing coupler, implemented according to the achievement of the object, having attached coaxial plug, and

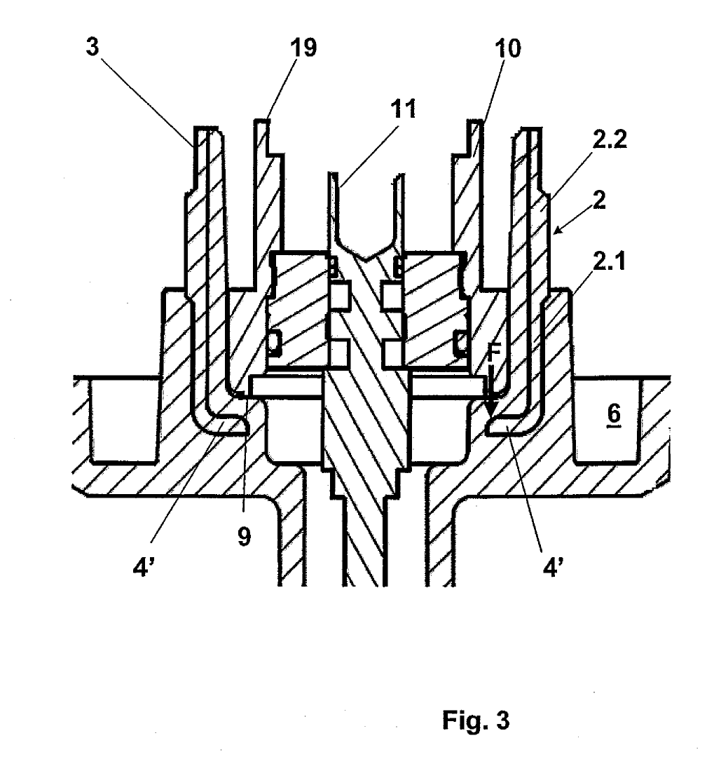

FIG. 3 shows a longitudinal sectional illustration through an HF housing coupler implemented according to the achievement of the object.

### DETAILED DESCRIPTION OF THE EXEMPLARY EMBODIMENTS, INDUSTRIAL APPLICABILITY

A combined longitudinal sectional illustration through two HF housing couplers implemented according to the achievement of the object, in which each of the two housing coupler halves shown on the indicated longitudinal axis A show alternative embodiments, is shown in FIG. 1.

Firstly, the exemplary embodiment shown in the right half of FIG. 1 is explained in greater detail, which shows an HF housing coupler which provides a plastic housing 1, which is produced in the course of the plastic injection-molding method, and a connector part 2 partially embedded therein. The sleeve-like connector part 2, which comprises metal, has two sleeve sections 2.1 and 2.2, which are integrally connected to one another, and of which the sleeve section 2.1 is nearly completely enclosed by plastic material of the housing 1 to implement a formfitting connection. The other sleeve section 2.2 projects beyond the wall of the housing 1 and has an external thread 3 on its upper peripheral edge. The union nut of a plug can be engaged with the external thread 3 for the detachable fixed fastening. Alternatively or in combination therewith, it is also possible to provide a bayonet joint or a similarly acting connection mechanism instead of the thread 3 on the sleeve section 2.2 for the detachable fixed accommodation of a plug.

In contrast, the sleeve section 2.1 embedded in the housing material provides structures 4 in the form of grooved depressions and/or web-like ribs, through which a close form fit with the housing material comprising plastic is producible, so that an active tightening torque, caused by a mutual thread twisting between a union nut of a plug and the thread 3, is transmittable directly to the housing 1, without the connector part 2 loosening relative to the housing 1 or even detaching.

For the production of the injection-molded housing 1 and the formfitting connection between the housing 1 and the metal connector part 2, an injection mold has been used through which the sleeve section 2.1 is completely enclosed on its peripheral circumference edge 2.11 by a web-like collar 5. In addition, the collar 5 is separated from the remaining material of the housing 1 by a trough-shaped recess 6. This contributes to the collar 5 sealing fluid-tight with the peripheral circumferential edge 2.11 of the sleeve section 2.1 of the connector part 2 through the shrinking of the plastic material during the cooling procedure upon the plastic injection, whereby penetration of moisture is prevented. Furthermore, the injection-molded housing part 1, as already noted, encloses the sleeve internal contour 4 of the sleeve section 2.1 to implement a formfitting connection and additionally provides a cylindrical hollow channel 7 coaxially to the sleeve-like connector part, which experiences an unsteady diameter enlargement in the area of the sleeve section 2.1 via an edge 8. The edge 8 is used as a mechanical counter stop for the external conductor sleeve 10 to be installed later.

However, before the external conductor sleeve 10 is mounted, the housing 1 is metallized together with the connector part 2 embedded therein, thus in particular the inner walls of the hollow channel 7 and edge area 8 produced during the injection-molding method. Furthermore, the installation of the metal external conductor sleeve 10, which adapts flush on the inner wall on one side on the hollow cylindrical internal contour of the connector part 2 and on the other side using its annular front face 9 to implement a close contact on the edge 8 and in particular on the metal layer deposited on the edge 8 to implement an electrical contact, is performed by pressing in.

The internal conductor component 11 provided in the interior of the external conductor sleeve 10 and the insulating support 12 supporting the internal conductor component 11 centrally inside the external conductor sleeve 10 have already been preinstalled before the external conductor sleeve 10 is pressed into the interior of the connector part 2. The installation of the housing coupler implemented according to the achievement of the object thus does not require complex method steps, so that the fabrication costs connected thereto may be kept low. Additional joining means are also not necessarily required for a fixed seat of the external conductor sleeve 10 inside the connector part 2, such as adhesively acting adhesive agents, because, as shown in the further description with reference to FIG. 2, a force acting axially from the outside on the external conductor sleeve 10 in the direction of the housing 1 is generated in the course of a connection with a plug, through which the external conductor sleeve 10 is pressed in the direction of the abutting edge 8. Before reference is made to FIG. 2, the left exemplary embodiment in FIG. 1 for the implementation of an HF housing coupler implemented according to the achievement of the object is explained hereafter.

In contrast to the embodiment variant described above, the modified connector part 2′ is simultaneously also used as the external conductor sleeve. For this purpose, the external conductor sleeve 10 described above and the connector part 2 have been combined into the modified connector part 2′. The modified connector part 2′ also provides a sleeve section 2.1′ connected formfitting to the housing material, in which the structures 4′ are now attached radially externally. The internal contour of the sleeve section 2.1′ is also implemented as cylindrical toward the hollow channel 7, so that a seamless transition is provided between the internal contour of the sleeve section 2.1′ and the hollow channel 7. To install the modified HF housing coupler, the component 2′ is embedded in the housing 1 and subsequently metallized, similarly to the above statements. In contrast to the above statements, however, the internal conductor component 11 and the insulating support 12 are subsequently to be introduced into the inner contour of the external conductor combined with the connector part.

In FIG. 2, a longitudinal sectional illustration through an HF housing coupler according to the first embodiment explained above is described, on which a plug 13 having union nut 14 is seated. The external conductor sleeve 10 of the HF housing coupler has a hollow-cylindrical contact collar 15, which provides an axially extending collar length I, which is greater than the collar length of a contact collar 16 provided on the plug-side external conductor sleeve 18, so that it is ensured that in the connected state shown in FIG. 2 of the coaxial plug 13 with the connector part 2, the coupler-side external conductor sleeve 10 and the plug-side external conductor sleeve 18 are under mechanical bias tension caused by the axially acting thread force of the union nut 14. In this way, the external conductor sleeve 10 of the HF housing coupler is pressed in particular via its annular front face 19 facing axially toward the plug 13 against a plug-side support face 20 to form a close physical and thus also electrical contact 17. The axially acting thread force of the union nut 14 not only ensures a secure compression between the external conductor sleeves 18 and 10 of the plug 13 and the coupler, but rather the axially acting thread force additionally also ensures a secure seat of the external conductor sleeve 10 of the coupler inside the connector part 2, in that the external conductor sleeve 10 is pressed against the electrical contact point provided on the housing side at the edge 8. Therefore, all high-frequency conducting external conductor components are held under mechanical bias tension in the installed state, whereby a continuous and sufficient contact pressure is ensured. The occurrence of intermodulation products by yielding of the components under additional load is thus avoided.

A further particularly advantageous embodiment of an HF housing coupler is shown in a longitudinal sectional illustration in FIG. 3, which is provided with the reference numerals already explained above. In a particularly simple way, the connector part 2 is implemented, for example, manufactured from a metal tubular piece, on whose upper end an external thread 3 is provided and whose lower tube end provides inwardly deformed tube wall areas 4′ at least sectionally along the tube peripheral edge. The at least regionally performed deformation of the lower tube end is preferably performed in the course of a cold deformation.

The connector part 2 prefinished in this way is embedded in the housing 1 in the way shown in FIG. 3, the inwardly bent and/or deformed lower tube wall sections 4′ coming to rest largely below the annular front faces 9 in axial projection. If, as explained above, axially oriented thread forces caused by a union nut (not shown in greater detail in FIG. 3) by engaging with the thread 3 of the connector part 2 act, the external conductor sleeve 10 is axially pressed against the annular front face 9 of the housing 1, so that the axially oriented contact forces F represented by the arrow shown in FIG. 3 act on the annular front face 9. The axially acting force F caused in this way is absorbed by the metal, inwardly bent tube wall sections 4′, however, so that shape degradation, for example, by cold flow in the area of the annular front face 9, can be prevented. Through the special geometric shaping of the connector part 2 shown in FIG. 3, all axially acting forces which arise through the tightening torque through a screw connection between a union nut and the thread 3 can be completely absorbed. A closed force flux results, which allows the plastic housing area in the region of the HF housing coupler to be nearly completely disregarded in the strength consideration.

In addition, the HF housing coupler implemented according to the achievement of the object differs from coupler systems known up to this point through the reduction of the number of the insert parts and a lower space requirement for the housing plug connector.

### LIST OF REFERENCE NUMERALS

1 housing
2 connector part
2′ modified connector part
2.1, 2.2 sleeve sections
2.1′, 2.2′ modified sleeve sections
3 connecting structure, thread
4 structures
4′ inwardly deformed tube wall sections
5 collar
6 trough-shaped recess
7 hollow channel
8 edge, counter stop
9 annular front face
10 external conductor sleeve
11 internal conductor component
12 insulating support
13 plug
14 union nut
15 coupler-side contact collar
16 plug-side contact collar
17 contact point
18 external conductor sleeve of the plug
19 coupler-side front face
20 plug-side support face

1. A HF housing coupler having a connector part connected to a housing, which has a connecting structure, via which a coaxial plug can be detachably connected to the connector part in a fixed manner, characterized in that the connector part is implemented as a component differentiable from the housing and provides at least one region, which at least sectionally forms a formfitting connection with a housing wall which can be associated with the housing.

2. The HF housing coupler according to claim 1, characterized in that the connector part is exclusively connected to the housing wall via the at least one formfitting connection.

3. The HF housing coupler according to claim 1, characterized in that the connector part comprises a metal material or a material which at least contains metal.

4. The HF housing coupler according to claim 1, characterized in that the housing is a plastic housing which is producible in the course of an injection-molding method or a method related to injection molding, in which free-flowing plastic cures in a pre-definable shape.

5. The HF housing coupler according to claim 4, characterized in that the housing is metallized in at least partial regions of its surface.

6. The HF housing coupler according to claim 1, characterized in that the housing wall at least partially encloses an installation space facing away from the connector part, into which high-frequency components or HF assemblies can be introduced.

7. The HF housing coupler according to claim 4, characterized in that the connector part is embedded in the housing wall material in the area of the at least one formfitting connection.

8. The HF housing coupler according to claim 7, characterized in that the connector part has a structured surface in the region of the formfitting connection.

9. The HF housing coupler according to claim 1, characterized in that the connector part is implemented as sleeve-like and provides a first sleeve section, which forms the at least one formfitting connection with the housing wall, and a second sleeve section, which is axially opposite to the first, and on which the connecting structure is provided in the form of a thread and/or a bayonet joint.

10. The HF housing coupler according to claim 9, characterized in that the first sleeve section is completely enclosed by the housing wall at least on its external circumferential edge.

11. The HF housing coupler according to claim 10, characterized in that the housing wall provides a peripheral collar on the circumferential edge in the area of the first sleeve section, which forms a fluid-tight seal with the circumferential edge on the radial interior.

12. The HF housing coupler according to claim 9, characterized in that the sleeve-like connector part at least regionally has an internal contour, into which an external conductor sleeve is introduced flush, which comprises a cavity, in which an internal conductor component is provided, which is connected via an insulating support to the external conductor sleeve.

13. The HF housing coupler according to claim 9, characterized in that the sleeve-like connector part is used as the external conductor sleeve and comprises a cavity, in which an internal conductor component is provided, which is connected via an insulating support to the external conductor sleeve.

14. The HF housing coupler according to claim 12, characterized in that the external conductor sleeve provides at least one internal sleeve section, which adapts flush on a hollow channel inside the housing wall which is metallized coaxially to the external conductor sleeve.

15. The HF housing coupler according to claim 12, characterized in that the external conductor sleeve provides a hollow cylindrical contact collar, which provides an axially extending collar length, which is greater than the collar length of a plug-side contact collar of the plug-side external conductor, so that in the connected state of the coaxial plug with the connector part, the coupler-side and the plug-side external conductors are under mechanical bias tension, which is directed in the axial direction toward the housing wall.

16. The HF housing coupler according to claim 15, characterized in that the contact collar of the external conductor sleeve provides an axially oriented front face, which is oriented facing axially toward a plug-side support face and can be pressed in the axial direction against it in the connected state to implement an electrical contact using mechanical bias tension.

17. The HF housing coupler according to claim 9, characterized in that the connector part is implemented like a tube part, and the first sleeve section has inwardly deformed tube wall sections in the area of the tube end.

18. The HF housing coupler according to claim 15, characterized in that the inwardly deformed tube wall sections are situated in axial projection below the plug-side support face.

19. A method for producing an HF housing coupler having a connector part connected to a housing, which has a connecting structure, via which a coaxial plug can be detachably connected to the connector part in a fixed manner, characterized in that the housing is produced in the course of a molding or casting method, in particular an injection-molding method, in which the connector part is embedded in a housing wall which can be associated with the housing in such a manner that the connector part at least regionally forms a formfitting connection with the housing wall.

20. The method according to claim 19, characterized in that a metal component or a component containing metal parts is used as the connector part and the housing is produced in the course of a plastic injection-molding method.

21. The method according to claim 19, characterized in that a hollow channel is provided in the course of the molding or casting method in the housing wall in the region of the connector part, and the housing is metallized at least in the area of the hollow channel.

22. The method according to claim 21, characterized in that an external conductor sleeve having an internal insulating part and an internal conductor component is pressed into a recess provided in the connector part in such a manner that the external conductor sleeve stops against an abutting edge provided in the housing wall, through which the external conductor sleeve is secured against forces acting in the pressing-in direction.
